(19) United States
(12) Patent Application Publication
(10) Pub. No.: US 2020/0174540 A1
(43) Pub. Date: Jun. 4, 2020

(54) Power Supply System, Method of Displaying Operating State of Power Supply Device, and Program

(71) Applicant: OMRON Corporation, Kyoto-shi, Kyoto (JP)

(72) Inventors: Koji TAKATORI, Kusatsu-shi (JP); Masaaki NAGANO, Kusatsu-shi (JP)

(73) Assignee: OMRON Corporation, Kyoto-shi, Kyoto (JP)

(21) Appl. No.: 16/640,722

(22) PCT Filed: Oct. 18, 2018
(86) PCT No.: PCT/JP2018/038805

§ 371 Date: Feb. 20, 2020

(30) Foreign Application Priority Data
Nov. 13, 2017 (JP) 2017-218429

(51) Int. Cl. G06F 1/28; H02M 3/335; G01K 13/00

(52) U.S. Cl. CPC G06F 1/28; G01K 13/00; H02M 3/33523

(57) ABSTRACT

The disclosure relates to a power supply system, a method of displaying an operating state of a power supply device and a program, by which an ambient temperature of the power supply device can be estimated and an operating state of the power supply device can be displayed. The power supply system according to an embodiment may include: a power supply device that is capable of estimating the ambient temperature based on internal measurement information; and a PC that obtains the operating state of the power supply device at the ambient temperature estimated by the power supply device. The PC causes a monitor to display the obtained operating state of the power supply device in comparison with a use condition determined in advance.

### TECHNICAL FIELD

The present invention relates to a power supply system, a method of displaying an operating state of a power supply device, and a program.

### BACKGROUND ART

Conventionally, in an installation environment in which a power supply device is installed in a control panel, the ambient temperature of the power supply device needs to be measured in the state where the power supply device is installed inside the control panel and also needs to be measured in the state where a thermocouple and the like are inserted into the control panel. Also, in the case where devices are installed in high density as in the control panel, it is necessary to select which portion should be measured for obtaining an ambient temperature of the power supply device.

Furthermore, PTL 1 discloses a power supply device, in which a CPU device calculates a load factor from the measured load current, and refers to the subtraction time in a subtraction time data table based on the measured temperature and the calculated load factor, so as to update the value of the remaining life time.

Furthermore, PTL 2 discloses a power supply device with reference to an example of a process of producing driving support data, in which a monitoring data processing device receives, from a power feeding device, data obtained by monitoring a voltage V, a current I, and a temperature T of the power feeding device in a constant cycle, and displays the data as the operating state of the power supply device at each time on a screen of a display device in a time series manner.

### CITATION LIST

### Patent Literature

PTL 1: Japanese Patent Laying-Open No. 2009-195044

PTL 2: Japanese Patent Laying-Open No. 2005-210802

### SUMMARY OF INVENTION

### Technical Problem

However, in PTL 1, only the internal temperature of the power supply device is measured for monitoring the life of the power supply device, but the ambient temperature of the power supply device cannot be estimated. Also in PTL 1, only the life of the power supply device is displayed, but it cannot be displayed what operating state arises in the power supply device under the use condition of the power supply device.

Furthermore, also in PTL 2, only the internal temperature of the power supply device is measured, but the ambient temperature of the power supply device cannot be estimated. Also in PTL 2, the data of voltage V, current I, and temperature T is merely displayed in time series as an operating state of the power supply device at each time on the screen of the display device, but it cannot be displayed what operating state arises in the power supply device under the use condition of the power supply device.

The present invention aims to provide a power supply system, a method of displaying an operating state of a power supply device, and a program, by which the ambient temperature of a power supply device can be estimated based on internal measurement information of the power supply device, and the operating state of the power supply device can be displayed.

### Solution to Problem

According to an aspect of the present invention, a power supply device that is capable of estimating an ambient temperature based on internal measurement information; and a computing processing device that obtains an operating state of the power supply device at the ambient temperature estimated by the power supply device are included. The computing processing device causes a display unit to display the obtained operating state of the power supply device in comparison with a use condition determined in advance.

Preferably, the use condition is a derating curve defined by the ambient temperature and a load factor of the power supply device.

Preferably, the computing processing device causes the display unit to display a time-series change in the operating state of the power supply device.

Preferably, based on data measured in advance about power supply devices having different specifications, the computing processing device causes the display unit to display a change in the operating state of the power supply device in a case of replacement with the power supply device that is in operation.

Preferably, the computing processing device causes the display unit to display a change in the operating state of the power supply device when a use temperature changes.

Preferably, the computing processing device causes the display unit to display a change in the operating state of the power supply device when a use time changes.

Preferably, the computing processing device gives a notification when the operating state of the power supply device deviates from the use condition.

Preferably, the power supply device includes: a power supply unit; a measurement unit that measures an internal temperature of the power supply unit as the internal measurement information; a computing unit that estimates the ambient temperature based on the internal temperature measured by the measurement unit and a load condition of the power supply unit; and an output unit that outputs the ambient temperature estimated by the computing unit to the computing processing device.

Preferably, a storage unit that stores a correspondence table of the ambient temperature based on the internal temperature and the load condition is further included. The computing unit estimates the ambient temperature corresponding to the measured internal temperature and the load condition based on the correspondence table stored in the storage unit.

Preferably, the load condition is a value related to at least one of an output current and an output voltage from the power supply unit.

Preferably, the computing unit calculates a temperature rise inside the power supply unit based on the load condition, and estimates the ambient temperature based on a difference between the temperature rise and the internal temperature.

Preferably, the measurement unit measures, as the internal temperature, a value of a temperature sensor that detects a temperature of a component forming the power supply unit.

According to another aspect of the present invention, a method of displaying an operating state for causing a display unit to display an operating state of a power supply device is provided. The method includes: obtaining, by a computing processing device, the operating state of the power supply device at an ambient temperature estimated by the power supply device based on internal measurement information; and causing a display unit to display the operating state of the power supply device in comparison with a use condition determined in advance, the operating state being obtained by the computing processing device.

According to still another aspect of the present invention, a program for controlling a computing processing device to cause a display unit to display an operating state of a power supply device is provided. The program includes: obtaining the operating state of the power supply device at an ambient temperature estimated by the power supply device based on internal measurement information; and causing a display unit to display the obtained operating state of the power supply device in comparison with a use condition determined in advance.

### Advantageous Effects of Invention

According to the power supply system related to the present technique, the ambient temperature of the power supply device can be estimated based on the internal measurement information of the power supply device, and the operating state of the power supply device can be displayed using the estimated ambient temperature.

### BRIEF DESCRIPTION OF DRAWINGS

FIG. 1 is a schematic diagram for illustrating the configuration of power supply system according to an embodiment of the present invention.

FIG. 2 is a block diagram showing the hardware configuration of a PC.

FIG. 3 is a block diagram for illustrating the configuration of a power supply device according to the embodiment of the present invention,

FIG. 4 is a diagram schematically showing an example of the inside of the power supply device according to the embodiment of the present invention.

FIG. 5 is a diagram showing an example of a correspondence table of an ambient temperature used in the power supply device according to the embodiment of the present invention.

FIG. 6 is a schematic diagram showing an example illustrating an operating state of a power supply device 100 of a power supply system according to the embodiment of the present invention.

FIG. 7 is a schematic diagram showing an example illustrating the operating state of the power supply device in the case of replacement with another model.

FIG. 8 is a schematic diagram showing an example in which the representation of a derating curve is changed.

FIG. 9 is a schematic diagram showing an example illustrating the operating state of the power supply device in the case where a use environment is changed.

FIG. 10 is a schematic diagram showing a display example in the case where the operating state of the power supply device goes outside the derating curve.

### DESCRIPTION OF EMBODIMENTS

In the following, the present embodiment will be described in detail with reference to the accompanying drawings, in which the same or corresponding components will be designated by the same reference characters.

### A. Application Example

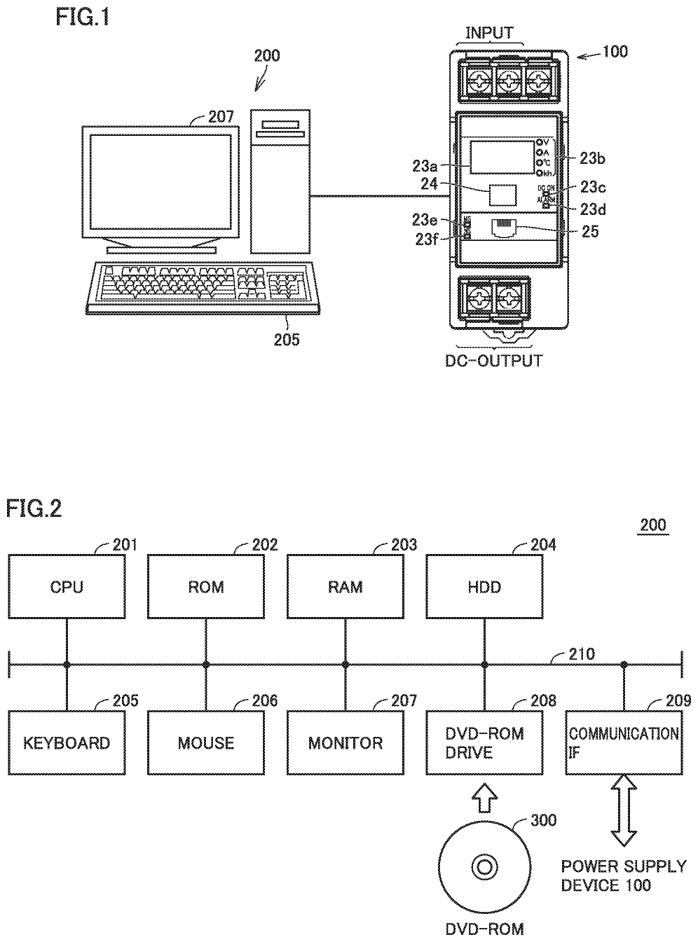

First, an application example of the present invention will be described with reference to FIG. 1. FIG. 1 is a schematic diagram for illustrating the configuration of a power supply system according to an embodiment of the present invention. The power supply system shown in FIG. 1 is formed of: a power supply device 100 installed inside a control panel; and a PC 200 (information processing unit) connected to power supply device 100. Power supply device 100 can estimate the ambient temperature based on the internal temperature (internal measurement information).

Furthermore, PC 200 can monitor the operating state of power supply device 100 using the ambient temperature estimated by power supply device 100 and can display the monitored operating state. In other words, PC 200 also serves as a management device for power supply device 100. PC 200 is connected to power supply device 100 by a connection cable 210 so as to allow communication therebetween. Connection between power supply device 100 and PC 200 is not limited to connection by wired connection cable 210, but also power supply device 100 and PC 200 may be connected through a wireless network.

### B. Configuration of PC

In the following, PC 200 (information processing unit) will be described. The following is an explanation about an example in which PC 200 is used without limitation as the means for displaying the operating state of power supply device 100, but the operating state of power supply device 100 may be able to be displayed by various types of display means such as a mobile phone, a smartphone, a tablet terminal, and a mobile PC.

FIG. 2 is a block diagram showing the hardware configuration of PC 200. Referring to FIG. 2, PC 200 includes as main components: a CPU 201 that executes a program; a read only memory (ROM) 202 in which data is stored in a non-volatile manner; a RAM 203 in which data generated by execution of the program by CPU 201 or data input through a keyboard 205 or a mouse 206 is stored in a volatile manner; a hard disk drive (HDD) 204 in which data is stored in a non-volatile manner; keyboard 205 and mouse 206 that receive an instruction input by the user of PC 200; a monitor 207; a DVD-ROM drive 208; and a communication IT 209. These components are connected to one another through a data bus. A DVD-ROM 300 is inserted into DVD-ROM drive 208.

The process in PC 200 is implemented by software executed by each hardware and CPU 201. Such software may be stored in HDD 204 in advance. Furthermore, software may be stored in DVD-ROM 300 or other storage media and distributed as a program product. Alternatively, software may be provided as a downloadable program product by the information provider connected to the so-called Internet. Such software is read from its storage medium by DVD-ROM drive 208 and other readers, or downloaded via communication IF 209, and then, temporarily stored in HDD 204. This software is read from HDD 204 by CPU 201 and stored in RAM 203 in the form of an executable program. CPU 201 executes this program.

Each of the components constituting PC 200 shown in the figure is commonly used. Therefore, the essential part of the present invention can be recognized as software stored in RAM 203, HDD 204, DVD-ROM 300, and other storage media, or as software downloadable via a network. Since the operation of each hardware in PC 200 is well known, the detailed description thereof will not be repeated.

A recording medium is not limited to a DVD-ROM, a CD-ROM, a flexible disk (FD), and a hard disk, but may be a medium fixedly carrying a program, such as a magnetic tape, a cassette tape, an optical disk (a magnetic optical disc (MO)/a mini disc (MD)/a digital versatile disc (DVD)), an integrated circuit (IC) card (including a memory card), an optical card, a mask ROM, a semiconductor memory such as an electronically programmable read-only memory (EPROM), an electronically erasable programmable read-only memory (EEPROM), a flash ROM, and the like. Furthermore, the recording medium is a non-transitory medium from which the program and the like can be read by a computer.

The program referred herein includes not only a program directly executable by a CPU but also a program in a source program form, a compressed program, an encrypted program, and the like.

### C. Configuration of Power Supply Device

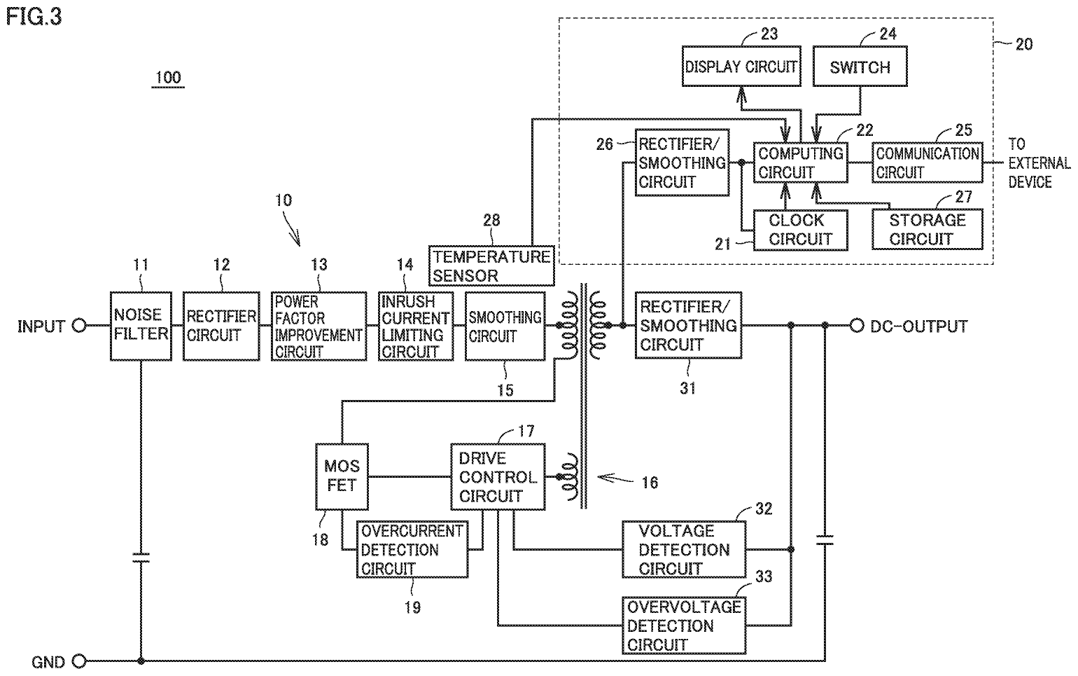

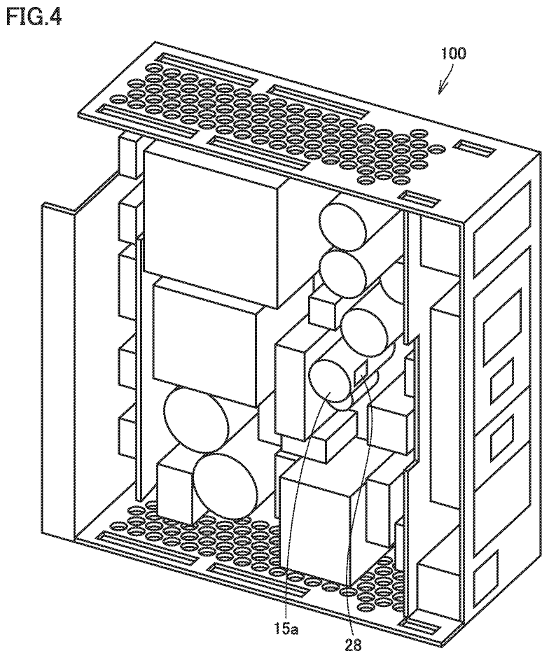

The configuration of the power supply device according to the embodiment of the present invention will be hereinafter described with reference to the accompanying drawings. FIG. 3 is a block diagram for illustrating the configuration of the power supply device according to the embodiment of the present invention. Power supply device 100 shown in FIG. 3 serves as a switching power supply device, and includes a power supply unit 10, a control unit 20, and a temperature sensor 28.

Power supply unit 10 includes a noise filter 11, a rectifier circuit 12, a power factor improvement circuit 13, an inrush current limiting circuit 14, a smoothing circuit 15, a transformer 16, a drive control circuit 17, a MOSFET 18, an overcurrent detection circuit 19, a rectifier/smoothing circuit 31, a voltage detection circuit 32, and an overvoltage detection circuit 33.

When an alternating-current (AC) power supply (for example, a commercial power supply of 50 Hz/60 Hz, and 100V/200V) is connected to noise filter 11 at an INPUT, a high-frequency noise component superimposed on the AC power supply is filtered to obtain an AC power supply from which the noise component is removed. Then, the obtained AC power supply is supplied to rectifier circuit 12.

Rectifier circuit 12 is formed of a full-wave rectifier circuit with a diode bridge, and performs full-wave rectification of the AC power supply received from noise filter 11 to achieve a pulsating flow to thereby generate a primary-side direct-current (DC) power supply.

Power factor improvement circuit 13 serves as a circuit for suppressing the harmonic current occurring in the input current, and is also referred to as a power factor correction (PFC) circuit. Inrush current limiting circuit 14 is formed, for example, of a resistance and a relay that is inserted in parallel with this resistance. Inrush current limiting circuit 14 serves to open the relay for few tens of milliseconds from start-up for preventing an inrush current, and then close the relay to allow start-up of the power supply. Smoothing circuit 15 is formed of a smoothing capacitor and serves to smooth the full-wave rectified AC power supply.

Drive control circuit 17 is formed of a control IC including a pulse width modulation (PWM) signal generator, a feedback control circuit, an over current protect (OCP) terminal, a switching drive terminal, a drive power supply terminal, and the like. Drive control circuit 17 supplies a high-frequency PWM signal to the gate of MOSFET 18 so as to drive MOSFET 18.

Furthermore, through a photocoupler (not shown), drive control circuit 17 feeds back the voltage on the secondary side (the output side) detected by voltage detection circuit 32. Then, based on the voltage, drive control circuit 17 changes the duty ratio of the PWM signal and drives MOSFET 18 such that the output voltage from the DC power supply becomes equal to a prescribed value. Furthermore, overcurrent detection circuit 19 is provided between drive control circuit 17 and MOSFET 18.

MOSFET 18 is connected in series to the primary winding of transformer 16, and connects and disconnects the DC power supply on the primary side in response to the PWM signal supplied from drive control circuit 17 so as to generate a high-frequency pulse power supply (AC power supply) in the primary winding.

Transformer 16 is formed of an insulation transformer providing electrical insulation between the primary side and the secondary side, and includes a primary winding, a secondary winding, and an auxiliary winding. Transformer 16 guides the high-frequency pulse power supply (AC power supply) generated in the primary winding to the secondary winding and the auxiliary winding. In addition, the high-frequency pulse power supply (AC power supply) guided to the secondary winding is utilized for a DC output power supply while the high-frequency pulse power supply (AC power supply) guided to the auxiliary winding is utilized for start-up of drive control circuit 17.

Rectifier/smoothing circuit 31 is formed of a half-wave rectifier circuit with a diode, and a smoothing capacitor, Rectifier/smoothing circuit 31 performs half-wave rectification of the high-frequency pulse power supply (AC power supply) guided to the secondary winding, and then, smoothes the resultant power supply, thereby generating a DC output power supply with a prescribed output voltage and a prescribed output current. The generated DC output power supply is output from a DC-OUTPUT.

Voltage detection circuit 32 detects the output voltage from the DC output power supply at a corresponding lowered voltage, and outputs the detected voltage to drive control circuit 17 through a photocoupler (not shown). Overvoltage detection circuit 33 is provided through a photocoupler (not shown) between the output side of the DC output power supply and drive control circuit 17.

Control unit 20 includes a clock circuit 21, a computing circuit 22, a display circuit 23, a switch 24, a communication circuit 25, a rectifier/smoothing circuit 26, and a storage circuit 27.

Clock circuit 21 is a timer that clocks the operating time of power supply unit 10. Clock circuit 21 clocks the time during which the DC output power supply is generated from the DC-OUTPUT, but does not clock the non-energization time.

Computing circuit 22 serves as a circuit that sums the times clocked by clock circuit 21 to calculate the summed operating time and that calculates the remaining life time or the ambient temperature. Furthermore, computing circuit 22 controls display of display circuit 23, receives a switching signal input from switch 24, and controls communication circuit 25, for example. Computing circuit 22 is formed of: a central processing unit (CPU) as a control center; a read only memory (ROM) storing a program, control data and the like by which the CPU is operated; a random access memory (RAM) functioning as a work area of the CPU; an input/output interface for maintaining the signal integrity with peripheral equipment; and the like.

Display circuit 23 serves as a display device provided on the surface of power supply device 100. In power supply device 100 shown in FIG. 1, display circuits 23a to 23f, switch 24, and communication circuit 25 are provided on the surface on which an INPUT terminal and a DC-OUTPUT terminal are provided.

Display circuit 23a is for example formed of a seven-segment LED allowing a triple-digit display and is capable of displaying the output voltage, the output current, the summed operating time, the remaining life time, the ambient temperature, and the like. Display circuit 23a may be an LCD, an organic electroluminescence display, and the like. Display circuit 23b includes four LED lamps arranged along the side of display circuit 23a. Among these four LED lamps, a lit-up LED lamp indicates the information of the value displayed on display circuit 23a. For example, when the LED lamp located adjacent to “V” lights up, the value displayed on display circuit 23a represents the output voltage from power supply device 100. When the LED lamp located adjacent to “A” lights up, the value displayed on display circuit 22a represents the output current from power supply device 100. When the LED lamp located adjacent to “° C” lights up, the value displayed on display circuit 23a represents the ambient temperature of power supply device 100. When the LED lamp located adjacent to “kh” lights up, the value displayed on display circuit 23a represents the information about the life of power supply device 100.

A display circuit 23c is formed of an LED lamp located below display circuit 23b. Lighting-up of this LED lamp indicates that the DC voltage is output from power supply device 100. A display circuit 23d is formed of an LED lamp located below display circuit 23c. Lighting-up of this LED lamp indicates that an abnormality occurs in power supply device 100. Display circuits 23e and 23f are two LED lamps arranged along the side of communication circuit 25. Lighting-up of these LED lamps indicates the communication status in communication circuit 25.

Switch 24 is a display changeover switch and serves to change the content displayed on display circuit 23. When a user depresses switch 24, a switching signal is input into computing circuit 22. Based on the input switching signal, computing circuit 22 changes the information displayed on display circuit 23a. For example, each time the user depresses switch 24, the information displayed on display circuit 23a is changed sequentially to the output voltage, the output current, the ambient temperature, and the information about the life of power supply unit 10 (the summed operating time or the remaining life time).

Communication circuit 25 serves as a circuit for communicating with an external device and is for example a wired network (for example, Ethernet (registered trademark)). As shown in FIG. 1, a connection terminal of the wired network is provided on the surface of power supply device 100 on which display circuit 23a is disposed. Connection cable 210 from PC 200 is connected to the connection terminal of the wired network shown in FIG. 1. It should be noted that communication circuit 25 is not limited to a wired network but may be known means such as a universal serial bus (USB) communication, serial communication, parallel communication, and a wireless network (for example, a wireless LAN, and BLUETOOTH (registered trademark)). Through communication circuit 25, the switching signal for changing the content displayed on display circuit 23 can be input from an external device, and also, the ambient temperature and the information about the life of power supply unit 10 (the summed operating time, the remaining life time and the like) can be output from computing circuit 22 to an external device.

Rectifier/smoothing circuit 26 is formed of a half-wave rectifier circuit with a diode and a smoothing capacitor, and performs half-wave rectification of the high-frequency pulse power supply (AC power supply) guided to the secondary winding, and then, smoothes the resultant power supply, thereby generating a DC output power supply with a prescribed output voltage and a prescribed output current. The generated DC output power supply is utilized for start-up of control unit 20.

Storage circuit 27 serves as a circuit for storing: the internal temperature of power supply device 100 measured by temperature sensor 28; the correspondence table used for estimating the ambient temperature of power supply device 100; the information about the life of power supply unit 10; and the like. Storage circuit 27 is formed of a non-volatile storage device such as flash memory, for example. The correspondence table stored in storage circuit 27 can be updated and edited by an external device through communication circuit 25.

Temperature sensor 28 serves as a sensor for measuring the temperature of an electrolytic capacitor used in smoothing circuit 15 and the like. FIG. 4 is a diagram schematically showing an example of the inside of the power supply device according to the embodiment of the present invention. In power supply device 100 shown in FIG. 4, temperature sensor 28 is attached to the side surface of an electrolytic capacitor 15a disposed inside the device. Temperature sensor 28 can measure the internal temperature of power supply device 100, particularly the temperature of electrolytic capacitor 15a, thereby allowing calculation of the remaining life time of power supply unit 10. The position at which temperature sensor 28 is attached is not limited to the side surface of electrolytic capacitor 15a, but may be the portion around the internal components (a capacitor, an FET, and the like) of power supply device 100 or may be the portion that generates significant heat inside power supply device 100.

### D. Estimation of Ambient Temperature

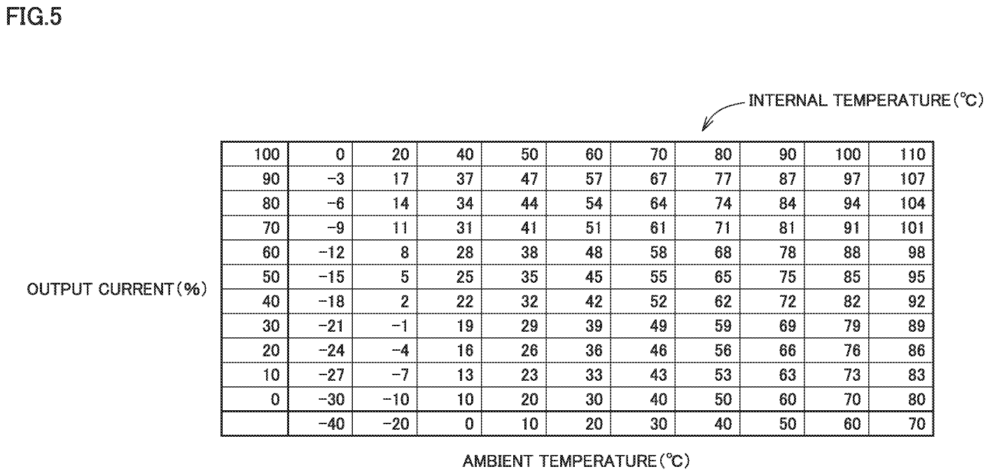

Temperature sensor 28 not only measures the internal temperature of power supply device 100 for calculating the remaining life time of power supply unit 10, but also performs measurement for estimating the ambient temperature of power supply device 100. Specifically, computing circuit 22 estimates the ambient temperature based on the internal temperature of power supply device 100 measured by temperature sensor 28 and the load condition of power supply unit 10. In order to estimate the ambient temperature, computing circuit 22 uses the correspondence table of the ambient temperature that is based on the internal temperature and the load condition and stored in storage circuit 27. FIG. 5 is a diagram showing an example of the correspondence table of the ambient temperature used in the power supply device according to the embodiment of the present invention. The correspondence table of the ambient temperatures shown in FIG. 5 shows: the output currents as the load conditions (unit of %; the maximum output current is defined as 100%) in the left column; and the values of the ambient temperatures (unit of ° C) in the bottom column that are specified by the respective output currents and the respective internal temperatures (unit of ° C.) measured by temperature sensor 28. For example, in the case where the output current from power supply device 100 is 50% and the internal temperature measured by temperature sensor 28 is 45° C., the value in the lower column of the correspondence table shows 20, so that the ambient temperature of power supply device 100 can be estimated as 20° C.

The correspondence table of the ambient temperatures shown in FIG. 5 varies depending on the specifications and the model of power supply device 100, and is stored in storage circuit 27 in advance by the manufacturer. The correspondence table of the ambient temperatures can also be updated through communication circuit 25, or may be able to be changed and edited by the user.

Inside power supply device 100, a temperature rises in accordance with the load condition of power supply unit 10. Thus, by subtracting this temperature rise from the internal temperature of power supply device 100 measured by temperature sensor 28, the ambient temperature of power supply device 100 can be estimated. Specifically, power supply device 100 calculates electric power from the output current and the output voltage measured as load conditions of power supply unit 10, and calculates the inside temperature rise caused by this electric power, thereby estimating the ambient temperature based on the difference between the internal temperature and the temperature rise. In the correspondence table of the ambient temperatures shown in FIG. 5, the estimated values of the ambient temperatures are summarized in a table in a manner corresponding to the respective internal temperatures and the respective load conditions. It should be noted that the load condition of power supply unit 10 may be the output current from power supply unit 10 as in the correspondence table of the ambient temperature shown in FIG. 5, or may be electric power of power supply unit 10. The load condition of power supply unit 10 may be any value as long as the value is related to at least one of the output current and the output voltage from power supply unit 10.

### E. Remaining Life Time

Based on the internal temperature (the temperature of the electrolytic capacitor) of power supply device 100 measured by temperature sensor 28, computing circuit 22 calculates the remaining life time to compute the information about the life of power supply unit 10. The electrolytic capacitor used in smoothing circuit 15 and the like of power supply device 100 is impregnated with an electrolyte solution, which permeates through sealing rubber since when this electrolytic capacitor is manufactured. Then, the internal electrolyte solution evaporates with time, thereby leading to deteriorations in characteristics such as capacitance reduction. The life of this electrolytic capacitor greatly depends on the life of power supply unit 10. Thus, computing circuit 22 calculates the remaining life time of power supply unit 10 based on the internal temperature of power supply device 100 measured by temperature sensor 28.

The deterioration amount of the electrolytic capacitor significantly varies depending on the internal temperature of power supply device 100. It is generally known that, according to the Arrhenius reaction rate theory, the deterioration amount of the electrolytic capacitor increases about twice when the ambient temperature changes by about 10° C. Thus, computing circuit 22 monitors the temperature of the operating electrolytic capacitor 15a using temperature sensor 28 as shown in FIG. 4 to calculate the remaining life time of power supply unit 10 based on the operating time and the internal temperature.

### F. Summed Operating Time

Computing circuit 22 sums the times clocked by clock circuit 21 to calculate the summed operating time so as to compute the information about the life of power supply unit 10. Computing circuit 22 obtains the summed operating time by summing only the times during which power supply unit 10 produces a DC output power supply. Thereby, computing circuit 22 can calculate the actual operating time. In addition, the information about the life of power supply unit 10 can be changed by depressing switch 24 shown in FIG. 1 and displayed on display circuit 23. Thus, the summed operating time and the remaining life time of power supply unit 10 can be displayed on display circuit 23.

### G. Display of Operating State of Power Supply Device

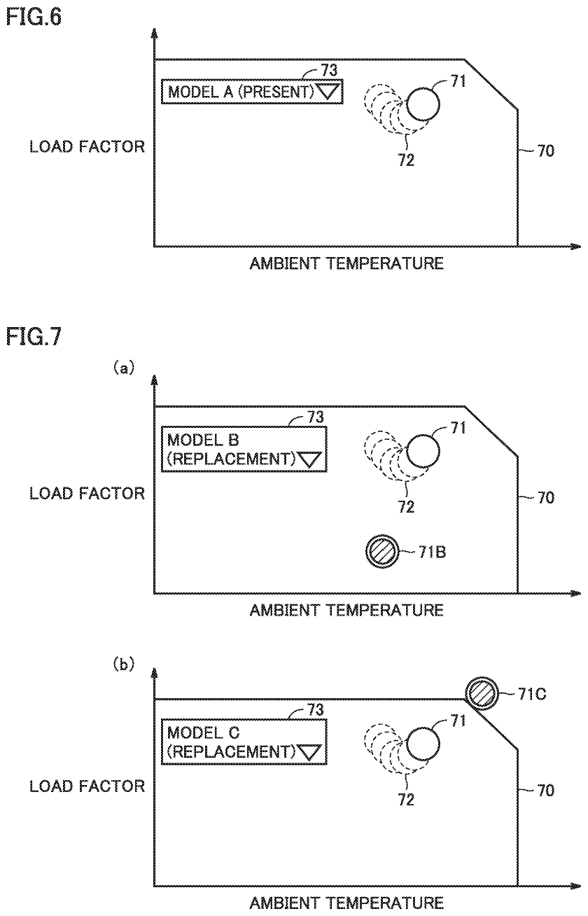

Then, PC 200 causes monitor 207 to display the operating state of power supply device 100 by utilizing the ambient temperature estimated by power supply device 100. FIG. 6 is a schematic diagram showing an example illustrating the operating state of power supply device 100 of the power supply system according to the embodiment of the present invention. On the display shown in FIG. 6, the horizontal axis represents the ambient temperature of power supply device 100 while the vertical axis represents the load factor. Also, a derating curve 70 is shown as a use condition of power supply device 100. In this case, the derating curve shows the use condition by which each of the specifications of power supply device 100 can be ensured, and is defined based on the “ambient temperature” at which the device is used and the “load factor” of the device. Derating curve 70 is defined for each model in consideration of the operating characteristics of the internal circuit that are attributable to the temperature rise and the temperature environment of the internal components. The load factor is a ratio (%) between the load current in power supply device 100 connected to a load and the rated current.

Power supply device 100 estimates the ambient temperature from the internal temperature of temperature sensor 28 as described above. PC 200 calculates a load factor by using, as a load current, the current measured inside power supply device 100 when a load is connected thereto. Then, PC 200 obtains the operating state of power supply device 100 at the ambient temperature estimated by power supply device 100. In other words, PC 200 is to obtain the coordinates (the ambient temperature, the load factor) on the display shown in FIG. 6. It should be noted that the load factor of power supply device 100 may be obtained by power supply device 100 itself and output to PC 200.

PC 200 causes monitor 207 to display the obtained operating state (the coordinates) of power supply device 100 in comparison with derating curve 70 that is specified in advance. Specifically, FIG. 6 shows an operating state 71 of present power supply device 100 inside derating curve 70. In addition to operating state 71 of present power supply device 100, FIG. 6 also shows an operating state 72 of past power supply device 100. Operating state 72 of past power supply device 100 is displayed, so that the background history of the operating state of power supply device 100 can be readily grasped while a future transition can also be readily estimated. FIG. 6 shows a display including a model display portion 73 that shows the information about the displayed model. This model display portion 73 shows the model of present power supply device 100 installed in the control panel as a “model A (present)”.

HDD 204 of PC 200 stores the data measured in advance about a plurality of models of power supply devices having different specifications, and stores, for example; the operating state of a model B that is larger in power supply capacitance than present power supply device 100; the operating state of a model C that is smaller in power supply capacitance than present power supply device 100; and the like. Furthermore, HDD 204 of PC 200 stores data about the power supply device measured in advance in each season, and data such as a change in the derating curve caused by secular changes in power supply device 100.

Accordingly, PC 200 can perform a simulation for the case where present power supply device 100 is replaced with the power supply device of model B, and the case where present power supply device 100 is replaced with the power supply device of model C. FIG. 7 is a schematic diagram showing an example illustrating the operating state of the power supply device in the case of replacement with another model. FIG. 7(a) shows the operating state of the power supply device in the state case where model B is selected from among the model names in a pull-down menu shown by clicking the display in model display portion 73 by a mouse or the like. Since the power supply device of model B is larger in power supply capacitance than present power supply device 100, PC 200 causes monitor 207 to display the simulation result of operating state 71B that is lower in ambient temperature and load factor than operating state 71 of present power supply device 100 (see FIG. 7(a)).

On the other hand, FIG. 7(b) shows the operating state of the power supply device in the state where model C is selected from among the model names in a pull-down menu shown by clicking the display in model display portion 73 by a mouse or the like. Since the power supply device of model C is smaller in power supply capacitance than present power supply device 100, PC 200 causes monitor 207 to display the simulation result of operating state 71C that is higher in ambient temperature and load factor than operating state 71 of present power supply device 100 (see FIG. 7(b)). The above-mentioned display results show that, in the case of replacement with the power supply device of model C, the operating state of the power supply device goes outside the derating curve. In this way, PC 200 can cause monitor 207 to display how the operating state of the power supply device changes in comparison with derating curve 70 when present power supply device 100 is replaced with another model of the power supply device. Thus, the user can readily grasp what kind of operating state occurs in the power supply device in the case of replacement with another model, so that the user can readily determine whether to replace the power supply device with another model or not.

In other words, PC 200 is a tool for displaying the result of simulation performed using the information such as the internal voltage, the internal current, and the internal temperature (internal measurement information) as to what kind of operating state occurs when present power supply device 100 is replaced with another power supply device, based on the data measured in advance about models for replacement (power supply devices having different capacitances). Furthermore, PC 200 not only can display the simulation result achieved when present power supply device 100 is simply replaced with another model of power supply device 100, but also can display the simulation result achieved, for example, when the power supply devices of the same model increased in number are operated in parallel, when the number of power supply devices is increased or decreased, and when a plurality of power supply devices are integrated into one. As a result, by PC 200, when the power supply capacitance is insufficient, the power supply capacitance is increased to lengthen the life of the power supply device, so that the number of steps in the replacement timing (maintenance) can be reduced. Also, when the power supply capacitance is sufficient, the power supply capacitance is decreased to reduce the size of the power supply device, so that the space and the size inside the control panel can be reduced.

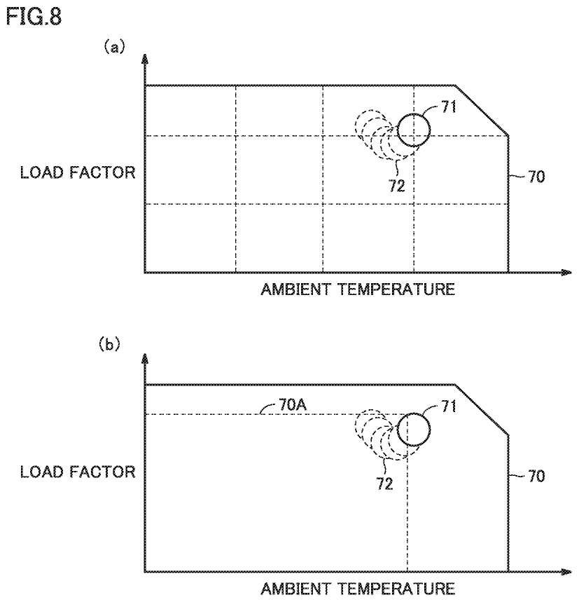

Furthermore, PC 200 can change the representation of derating curve 70. FIG. 8 is a schematic diagram showing an example in which the representation of derating curve 70 is changed. In FIG. 8(a), derating curve 70 is divided into a plurality of regions based on the ambient temperature and the load factor. Specifically, derating curve 70 is divided based on the ambient temperature into four regions, each of which is then divided based on the load factor into three regions, thereby obtaining twelve regions. By dividing derating curve 70 into a plurality of regions, it can be readily visually grasped to which region operating state 71 of power supply device 100 belongs. Thus, it can be readily determined to what extent the power supply capacitance is sufficient with respect to derating curve 70.

In FIG. 8(b), an optional curve 70A is set separately from derating curve 70. For example, by setting the use condition (optional curve 70A) severer than that of derating curve 70, PC 200 can manage power supply device 100 more safely. Furthermore, by setting optional curve 70A in accordance with the user's use condition, PC 200 can conduct management according to the user's use condition.

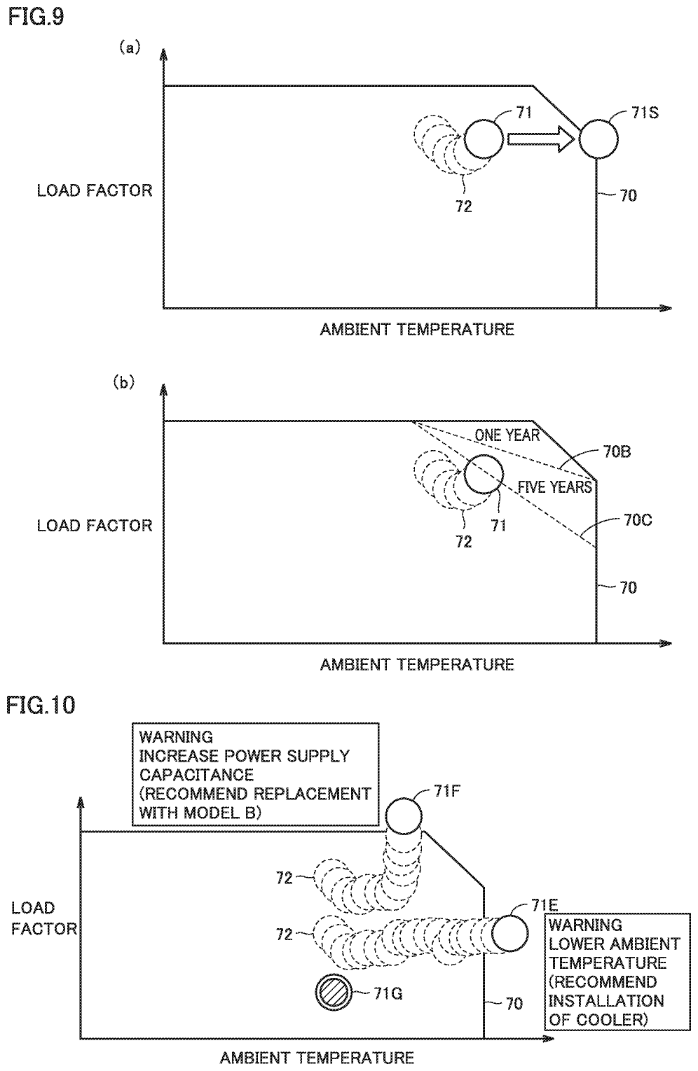

Furthermore, PC 200 can simulate the change of the use environment of power supply device 100. FIG. 9 is a schematic diagram showing an example illustrating the operating state of power supply device 100 in the case where the use environment is changed. FIG. 9(a) shows the case where the use temperature of the use environment changes, for example, shows what kind of operating state 71 occurs in power supply device 100 when the use environment changes from the winter season to the summer season. Specifically, in the case of the winter season, operating state 71 of power supply device 100 is inside derating curve 70. However, in the summer season, the ambient temperature becomes higher, and an operating state 71S of power supply device 100 goes outside derating curve 70. Based on the data measured in advance, PC 200 obtains operating state 71S of power supply device 100 in the summer season that has been changed from operating state 71 of power supply device 100 in the winter season. Then, PC 200 causes monitor 207 to display the obtained operating state 71S of power supply device 100 Thereby, the user can readily grasp how the operating state of power supply device 100 changes in accordance with the change of the use environment such as seasons.

FIG. 9(b) shows the case where the use time of the use environment of power supply device 100 changes, for example, shows how derating curve 70 changes. Specifically, a derating curve 70B occurring five years later lacks a part thereof as compared with derating curve 70 occurring one year later. Also, a derating curve 70C occurring ten years later further lacks a part thereof as compared with derating curve 70B occurring five years later. Based on the data measured in advance, PC 200 causes monitor 207 to display the change in the derating curve caused by aged deterioration of power supply device 100. Thereby, the user can readily grasp how operating state 71 of power supply device 100 changes with respect to the derating curve due to the aged deterioration of power supply device 100.

Furthermore, PC 200 gives a notification such as a warning when the operating state of power supply device 100 goes outside the derating curve. FIG. 10 is a schematic diagram showing a display example in the case where the operating state of the power supply device goes outside the derating curve. First, an operating state 71E of power supply device 100 shows the case where the ambient temperature becomes higher and goes outside the derating curve. In this case, PC 200 give a notification by causing monitor 207 to display a warning such as a message stating “lower the ambient temperature”, and also presents countermeasures, for example, by recommending installation of a cooler in a control panel. Thereby, the user can recognize that the operating state of power supply device 100 goes outside the derating curve, and also can learn the countermeasures therefor.

Furthermore, in an operating state 71F of power supply device 100, the load factor becomes higher and goes outside the derating curve. In this case, PC 200 give a notification by causing monitor 207 to display a warning such as a message stating “increase the power supply capacitance”, and also presents countermeasures, for example, by recommending replacement with model B having larger power supply capacitance. When PC 200 proposes replacement with model B having larger power supply capacitance, PC 200 may cause monitor 207 to display an operating state 71G occurring in the case of replacement with model B. Thereby, the user can also recognize the operating state of power supply device 100 occurring as a result of executing the countermeasures.

As described above, the power supply system according to the embodiment of the present invention includes: power supply device 100 capable of estimating the ambient temperature based on the internal measurement information (for example, the internal current, the internal voltage, the internal temperature, and the like); and PC 200 that obtains the operating state of power supply device 100 at the ambient temperature estimated by power supply device 100. PC 200 causes monitor 207 to display the obtained operating state of power supply device 100 in comparison with the use condition determined in advance. Accordingly, the power supply system can estimate the ambient temperature of the power supply device using the temperature sensor provided inside the power supply device, and can display the operating state of the power supply device based on the estimated ambient temperature.

The use condition is a derating curve defined by the ambient temperature and the load factor of the power supply device, for example. In addition to the derating curve, an optional curve may be set as the use condition.

PC 200 may also cause monitor 207 to display a time-series change in the operating state of power supply device 100. As shown in FIG. 6, by displaying operating state 72 of past power supply device 100, the background history of the operating state of power supply device 100 can readily be grasped while the future transition can readily be estimated.

Based on the data measured in advance about the power supply devices having different specifications, PC 200 may cause monitor 207 to display the change in the operating state of the power supply device in the case of replacement with the power supply device that is in operation. Accordingly, the user can readily grasp what kind of operating state occurs in the power supply device in the case of replacement with another model of the power supply device having different specifications, and thus, can readily determine whether to replace the power supply device or not.

PC 200 may cause monitor 207 to display the change in the operating state of the power supply device when the use temperature changes. Thus, the user can readily grasp how the operating state of power supply device 100 changes according to the change in the use environment such as seasons.

PC 200 may cause monitor 207 to display the change in the operating state of the power supply device when the use time changes. Thus, the user can readily grasp how operating state 71 of power supply device 100 changes with respect to the derating curve due to aged deterioration of power supply device 100.

PC 200 may give a notification when the operating state of the power supply device deviates from the use condition. Thus, the user can recognize that the operating state of power supply device 100 goes outside the derating curve and also can learn the countermeasures therefor.

Power supply device 100 includes power supply unit 10, a temperature sensor 28, computing circuit 22, and communication circuit 25. Temperature sensor 40 measures the internal temperature of power supply unit 10. Computing circuit 22 estimates the ambient temperature based on the internal temperature measured by temperature sensor 40 and the load condition of power supply unit 10. Communication circuit 25 outputs the ambient temperature estimated by computing circuit 22 to PC 200. Thus, power supply device 100 estimates the ambient temperature based on the internal temperature measured by temperature sensor 40 and the load condition of power supply unit 10, so that the ambient temperature of power supply device 100 can be obtained, thereby allowing appropriate derating and the like.

Furthermore, in power supply device 100, storage circuit 27 stores the correspondence table of the ambient temperatures based on the internal temperatures and the load conditions (see FIG. 5), and therefore, computing circuit 22 estimates the ambient temperature corresponding to the measured internal temperature and the load condition based on the correspondence table stored in storage circuit 27. Accordingly, computing circuit 22 estimates the ambient temperature based on the correspondence table, thereby allowing alleviation of the processing burden on control unit 20.

It should be noted that the load condition may be a value related to at least one of the output current and the output voltage from power supply unit 10. The load condition is electric power of power supply unit 10, for example. In other words, the load condition is not limited to the value such as the output current directly measured from power supply unit 10 as long as the internal temperature rise can be calculated thereby.

The operating state display method for causing monitor 207 to display the operating state of power supply device 100 according to the embodiment of the present invention includes: obtaining, by PC 200, the operating state of power supply device 100 at the ambient temperature estimated by power supply device 100 based on the internal measurement information; and causing the display unit to display the operating state of power supply device 100 obtained by PC 200 in comparison with the use condition determined in advance.

The program for controlling PC 200 to cause monitor 207 to display the operating state of power supply device 100 according to the embodiment of the present invention includes: obtaining the operating state of power supply device 100 at the ambient temperature estimated by the power supply device based on the internal measurement information; and causing monitor 207 to display the obtained operating state of power supply device 100 in comparison with the use condition determined in advance.

### Modification

In the above description of power supply device 100, computing circuit 22 estimates the ambient temperature corresponding to the measured internal temperature and the load condition based on the correspondence table stored in storage circuit 27. Without limitation to the above, in power supply device 100, computing circuit 22 may estimate the ambient temperature without using the correspondence table. For example, in power supply device 100, computing circuit 22 calculates the temperature rise inside power supply unit 10 based on the load condition, and estimates the ambient temperature based on the difference between the temperature rise and the internal temperature. Thus, power supply device 100 does not need to cause storage circuit 27 to store the correspondence table, and therefore, does not need to include storage circuit 27 itself.

As long as temperature sensor 28 can measure the internal temperature of power supply device 100, this temperature sensor 28 may be a temperature sensor for calculating the remaining life time of power supply unit 10, may be a temperature sensor for detecting overheating of power supply unit 10, or may be a temperature sensor for detecting the temperature of each of the components forming power supply unit 10. The internal temperature of power supply device 100 is measured using the temperature sensor for calculating the remaining life time of power supply unit 10, thereby eliminating the need to separately provide a temperature sensor for measuring the ambient temperature of power supply device 100.

PC 200 may propose countermeasures as follows. Specifically, when the power supply device needs to be operated in the desired operating state inside the derating curve, the area corresponding to the desired operating state inside the derating curve shown in FIG. 6 is clicked to thereby allow designation of this area (for example, selection of the model of the power supply device, the countermeasures against heat for a control panel, and the like).

It should be understood that the embodiments disclosed herein are illustrative and non-restrictive in every respect. The scope of the present invention is defined by the terms of the claims, rather than the description above, and is intended to include any modifications within the meaning and scope equivalent to the terms of the claims.

### REFERENCE SIGNS LIST

10 power supply unit, 11 noise filter, 12 rectifier circuit, 13 power factor improvement circuit, 14 inrush current limiting circuit, 15 smoothing circuit, 26, 31 rectifier/smoothing circuit, 16 transformer, 17 drive control circuit, 18 MOSFET, 19 overcurrent detection circuit, 20 control unit, 21 clock circuit, 22 computing circuit, 23 display circuit, 24 switch, 25 communication circuit, 27 storage circuit, 28 temperature sensor, 32 voltage detection circuit, 33 overvoltage detection circuit, 100 power supply device, 200 PC, 207 monitor.

1. A power supply system comprising:
a power supply device that is capable of estimating an ambient temperature based on internal measurement information; and
a computing processing device that obtains an operating state of the power supply device at the ambient temperature estimated by the power supply device, wherein
the computing processing device causes a display unit to display the obtained operating state of the power supply device in comparison with a use condition determined in advance.

2. The power supply system according to claim 1, wherein the use condition is a derating curve defined by the ambient temperature and a load factor of the power supply device.

3. The power supply system according to claim 1, wherein the computing processing device causes the display unit to display a time-series change in the operating state of the power supply device.

4. The power supply system according to claim 1, wherein
based on data measured in advance about power supply devices having different specifications, the computing processing device causes the display unit to display a change in the operating state of the power supply device in a case of replacement with the power supply device that is in operation.

5. The power supply system according to claim 1, wherein the computing processing device causes the display unit to display a change in the operating state of the power supply device when a use temperature changes.

6. The power supply system according to claim 1, wherein the computing processing device causes the display unit to display a change in the operating state of the power supply device when a use time changes.

7. The power supply system according to claim 1, wherein the computing processing device gives a notification when the operating state of the power supply device deviates from the use condition.

8. The power supply system according to claim 1, wherein
the power supply device includes:
a power supply unit;
a measurement unit that measures an internal temperature of the power supply unit as the internal measurement information;
a computing unit that estimates the ambient temperature based on the internal temperature measured by the measurement unit and a load condition of the power supply unit; and
an output unit that outputs the ambient temperature estimated by the computing unit to the computing processing device.

9. The power supply system according to claim 8, further comprising a storage unit that stores a correspondence table of the ambient temperature based on the internal temperature and the load condition, wherein
the computing unit estimates the ambient temperature corresponding to the measured internal temperature and the load condition based on the correspondence table stored in the storage unit.

10. The power supply system according to claim 8, wherein the load condition is a value related to at least one of an output current and an output voltage from the power supply unit.

11. The power supply system according to claim 8, wherein the computing unit calculates a temperature rise inside the power supply unit based on the load condition, and estimates the ambient temperature based on a difference between the temperature rise and the internal temperature.

12. The power supply system according to claim 8, wherein the measurement unit measures, as the internal temperature, a value of a temperature sensor that detects a temperature of a component forming the power supply unit.

13. A method of displaying an operating state for causing a display unit to display an operating state of a power supply device, the method comprising:
obtaining, by a computing processing device, the operating state of the power supply device at an ambient temperature estimated by the power supply device based on internal measurement information; and
causing a display unit to display the operating state of the power supply device in comparison with a use condition determined in advance, the operating state being obtained by the computing processing device.

14. A non-transitory storage medium storing thereon program for controlling a computing processing device to cause a display unit to display an operating state of a power supply device, the program comprising:
obtaining the operating state of the power supply device at an ambient temperature estimated by the power supply device based on internal measurement information; and
causing a display unit to display the obtained operating state of the power supply device in comparison with a use condition determined in advance.
